(19) United States
(12) Patent Application Publication
(10) Pub. No.: US 2017/0122297 A1
(43) Pub. Date: May 4, 2017

(54) AN EQUIPMENT COMPARTMENT FRAME OF A POWER CONTROL MODULE OF A WIND POWER TURBINE AND METHODS RELATED THERETO

(71) Applicant: VESTAS WIND SYSTEMS A/S, Aarhus N. (DK)

(72) Inventors: Erland Falk HANSEN, Morke (DK); Steffen HOUGAARD, Risskov (DK)

(73) Assignee: Vestas Wind Systems A/S, Aarhus N. (DK)

(21) Appl. No.: 15/128,493

(22) PCT Filed: Mar. 23, 2015
(86) PCT No.: PCT/DK2015/050063

§ 371 Date: Sep. 23, 2016

(30) Foreign Application Priority Data
Mar. 28, 2014 (DK) PA 2014 70162

(51) Int. Cl. F03D 80/80; E04B 1/58; E04B 1/24; E04H 5/04

(52) U.S. Cl. CPC F03D 80/82; E04H 5/04; E04B 1/5831; E04B 1/24; F05B 2230/50; F05B 2240/912; E04B 2001/2496

(57) ABSTRACT

The invention relates to an equipment compartment frame of a power control module of a wind turbine. The frame includes a polygonal beam structure (17) in one plane and a plurality of standing beams (18) attached to the polygonal beam structure (17) at at least some of the corners of the polygonal beam structure (17). According to the invention, each standing beam (18) is attached to the polygonal beam structure (17) by means of a releasable joint (26, 27, 28). The invention also relates to methods for transporting and assembling such frames.

### FIELD OF INVENTION

The present invention generally relates to the frame structures of a power control module and to methods for the transportation and assembly of these.

In a first aspect the invention relates to an equipment compartment frame of a power control module of a wind turbine, which frame includes a polygonal beam structure in one plane and a plurality of standing beams attached to the polygonal beam structure at at least some of the corners of the beam structure.

In a second aspect the invention relates to a method for transportation of an equipment compartment frame of a power control module of a wind turbine, which frame when assembled includes a polygonal beam structure and a plurality of standing beams attached to the polygonal beam structure at at least some of the corners of the polygonal beam structure.

In a third aspect the invention relates to a method for assembling an equipment compartment frame of a power control module of a wind power turbine.

And in a fourth aspect the invention relates to a method for transportation of a frame housing a power control module of a wind turbine, said frame of the power control module having a plurality of equipment compartment frames, each equipment compartment frame having a plurality of vertical sides each side being an orthogonal quadrangle and being limited by rigid structural elements.

The various aspects of the invention are all linked together by a common inventive concept, although claimed in four independent claims. All aspects of the invention thus relate to the basic inventive idea regarding a rationalized transportation and assembly of the frame of the power control module (PCM) and to subparts of such a frame.

### BACKGROUND OF INVENTION

A wind turbine with horizontal axis includes the main components turbine blades, a nacelle on which the blades are mounted and in which the electric generator is housed, a tower, at the top of which the nacelle is mounted and power control module arranged at the bottom of the tower. Transportation of the components and the assembling of these are circumstantial due to the high weight and the large dimensions and represent a considerable part of the costs for erecting a wind turbine. It is therefore important to arrange for the transportation and installation to be as rational as possible. The general object of the present invention is to attain improvements in this respect, in particular with regards to the framework of the power control module.

The power control module contains the equipment required for the control of the turbine and for transferring the generated current to an appropriate electric output for the grid. The PCM thus may include a transformer, a converter, internal power supply and other mechanical and electrical accessories as well as a structural framework including platforms. The PCM may be divided into compartments arranged above each other, e.g. three compartments. Typically the transformer may be located in the lowermost compartment, the converter in the intermediate compartment and other equipment and sub-system in the uppermost compartment.

The PCM is contained in a frame including vertical and horizontal beams and horizontal platforms supporting the equipment of the PCM. The frame of the PCM is built up by a number of equipment compartment frames, normally three, one for each equipment compartment.

The size of a PCM is quite large with a height in the order of 10 meters and even more. This represents a challenging transportation task, in particular when different kind of transportation means are required as is the case for supply to off-shore based wind turbines.

Representative examples of PCM:s mounted in frames are disclosed e.g. in EP 1788242, EP 2280168, EP 2108816, WO 2010193114, WO 2012130245 and DE 102010053360.

The exemplified prior art all suffer from the problem of bulky, costly and risky transportation.

### SUMMARY OF INVENTION

The object of the present invention is to improve the transportation and assembling to reduce the above mentioned problems.

This object is according to the first aspect of the invention achieved in that an equipment compartment frame of the kind specified in the preamble of claim 1 includes the specific features specified in the characterizing portion thereof. Thus each standing beam is attached to the polygonal beam structure by means of a releasable joint.

By a releasable joint is meant a joint that easily can be released as well as brought together. By such a construction of the equipment compartment frame, the frame can be transported unassembled to a site remote from the manufacturing site, e.g. to the erection site of the wind turbine or to an assembly site where the PCM is assembled. The transport volume thereby is reduced to a small fraction in comparison to an assembled transport of the equipment compartment frame. Due to the releasable joint the assembly can be easily made at the site remote from the manufacturing site.

According to a preferred embodiment of the invented equipment compartment frame, the polygonal beam structure is a quadrangle having a standing beam at each corner.

This embodiment is an adaption to the fact that the frame in most cases have a rectangular or square base.

According to a further preferred embodiment, the releasable joint is a bolt joint

This provides the easiest way for joining the standing beams to the polygonal beam structure.

According to a further preferred embodiment, the standing beams have a length that exceeds the lengths required for one equipment compartment frame and is attached to more than one polygonal beam structure.

Thereby the beams may form the vertical extension of two or all three compartments of the PCM. The stability is also increased.

The above mentioned preferred embodiments of the invented frame are specified in the claims depending from claim 1.

According to the second aspect of the invention, a method of transportation of an equipment compartment frame of the kind specified in the preamble of claim 5 includes the specific measure specified in the characterizing portion thereof. The frame thus is transported in disassembled state in which the standing beams are separated from the polygonal beam structure.

This invented method makes use of the possibilities offered by the invented equipment compartment frame and gains from the advantages attained therewith as presented above.

According to a preferred embodiment of this method a plurality of beam structures are transported, and the standing beams have a length adapted for the formation of a plurality of equipment compartment frames.

According to the third aspect of the invention, the object is achieved in that a method of assembling according to the preamble of claim 7 includes the specific steps specified in the characterizing portion thereof. The method thus includes the following steps:
at least one polygonal beam structure in one plane is manufactured at a manufacturing site,
a plurality of beams intended to be standing beams of the equipment compartment frame are manufactured at said manufacturing site or at a second manufacturing site,
the at least one polygonal beam structure and the beams are transported to an assembly site according to the method of the second aspect of the invention, and
at the assembly site the beams are attached to corners of the polygonal beam structure in standing positions relative to the plane of the polygonal.

According to a preferred embodiment of this method each beam is attached to the polygonal beam structure by a releasable joint.

According to a further preferred embodiment the releasable joint is a bolt joint.

Preferably the beam structure is a rectangle or a square. The advantages of the invented method for assembly and the preferred embodiments thereof can be understood by the advantages described above in relation to the invented equipment compartment frame and the preferred embodiments thereof.

The above mentioned preferred embodiments of the method according to the third aspect of the invention are specified in the claims depending from claim 7.

According to the fourth aspect of the invention, the object is achieved in that a method for transportation of a frame of a PCM including a PMC of the kind specified in the preamble of claim 10 includes the specific measure specified in the characterizing portion thereof. Thus the at least one of the sides of the at least one compartment is latched by at least one diagonally extending rigid bar or by two crossing, diagonally extending wires.

Transport of the completed PCM in the PCM frame means the transport of a very heavy item inducing high stresses in the framework. Due to the rectangular or square open sides the stability is not the best. If the PCM is somewhat tilted from the vertical position, a side might be deformed to the shape of a rhomboid or a rhomb, respectively. This might threaten the security. By securing a side with a latching bar connecting diagonal corners or by two crossing wires, the stability is increased and the mentioned problem is reduced. The latching bars may be removed when the PCM is installed in the tower of the wind turbine.

The diagonally extending bar may connect two diagonal corners of one side of an equipment compartment frame, or connect two diagonally located corner of the sides of two equipment compartment frames or even all three.

According to a preferred embodiment of this method the side is latched by two crossing rigid bars. This further increases the stability. Alternatively weaker bars may be used to obtain the same stability.

According to a further preferred embodiment, more than one of the sides of an equipment compartment frame are latched.

Preferably all sides are latched.

According to a further preferred embodiment more than one of the compartments are latched.

Preferably all compartments are latched.

The two embodiments mentioned next above both contribute to increase the stability or to allow the use of weaker latching bars/wires than otherwise required to obtain the same stability.

According to a further preferred embodiment of this method it includes the preceding steps of assembling the equipment compartment frame according to the third aspect of the invention, in particular to any of the preferred embodiments thereof, and assembling a plurality of equipment compartment frames to form a frame of a PCM and mount the equipment of the PCM in the frame.

This embodiment represents a complete chain of measures meeting the requirement of a non-bulky, cost-effective and secure transport, incorporating all the advantages mentioned above for the various aspects of the invention.

The above mentioned preferred embodiments of the method according to the fourth aspect of the invention are specified in the claims depending from claim 8.

It is to be understood that further preferred embodiments of the various aspects of the invention may be constituted by any possible combination of features of the various embodiments and by any possible combination of these with features mentioned in the description of examples below.

### BRIEF DESCRIPTION OF THE DRAWINGS

FIG. 1 is a side view of a PCM installed in a wind turbine tower

FIG. 2 is a perspective view of a first part of a PCM frame according to a first example of the invention.

FIG. 3 is a perspective view of a set of second parts of the PCM frame according to the first example.

FIG. 4 is a perspective view of the parts in figs.2 and 3 assembled.

FIG. 5 is a side view of a PCM frame according to a second example of the invention.

FIG. 6 is a flow chart illustrating the transport and assembly according to a further example of the invention.

FIGS. 7-9 are views corresponding to those of FIGS. 2-4 and illustrate an alternative example to that of these figures.

FIGS. 10 and 11 are views corresponding to that of FIG. 5 and illustrate alternative examples to the one of that figure.

The drawings are schematically in order to elucidate only those aspects that are important for understanding the principles of the invention. It is thus to be understood that the illustrated devices in practice include a lot more components and details.

### DESCRIPTION OF EXAMPLES

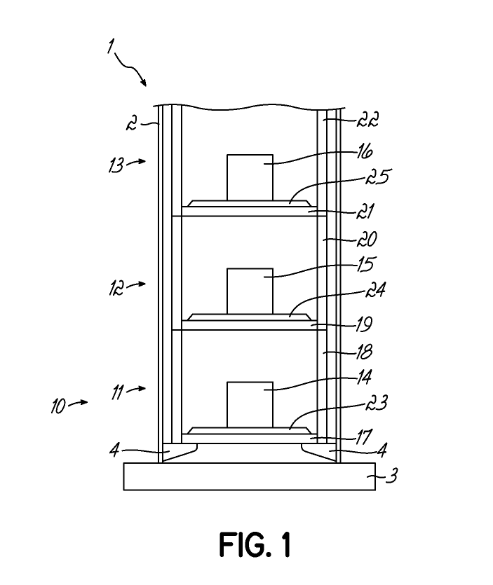

FIG. 1 shows a typical PCM together with its framework installed in a wind turbine tower and has mainly the purpose to provide a contextual background of the invention. The PCM 1 is mounted in the bottom of the wind turbine tower 2, which is secured to a foundation 3. The PCM 1 is supported in the tower 2 by consoles 4 attached to the tower. Alternatively the PCM may hang suspended in the tower.

The PCM 1 includes the equipment required for controlling and operating the wind turbine. The equipment is mounted within a PCM frame 10. The PCM 1 is divided into three compartments arranged above each other. Each compartment includes a part of the PCM frame 10, in this application such part is called equipment compartment frame. The lowermost equipment compartment frame 11 houses a transformer 14, the intermediate equipment compartment frame 12 houses a converter 15 and the uppermost equipment compartment frame 13 houses internal power supply devices 16. A plurality of other kinds of equipment is normally also present in the compartments.

The lowermost equipment compartment frame 11 consists of a rectangular or square beam structure 17 in the bottom plane of the compartment. To this beam structure 17 a standing beam 18 is attached at each corner. These standing beams 18 are connected to the bottom beam structure 19 of the intermediate equipment compartment frame 12. The other two equipment compartment frames 12, 13 have similar construction with standing beams 20, 22. The equipment components rest on a respective platform 23, 24, 25 supported by the respective bottom beam structure 17, 19, 21. The height of the PCM is typically in the order of 10 meters or above.

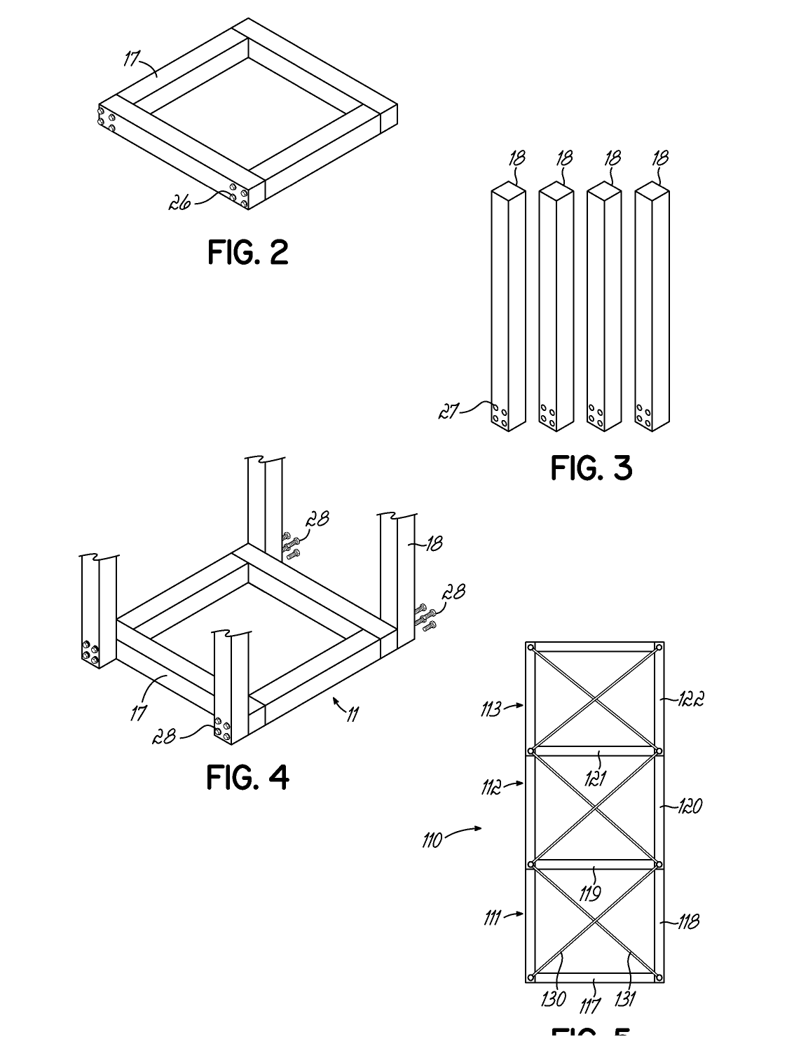

FIGS. 2-4 illustrate how an equipment compartment frame is transported and assembled. FIG. 2 shows the bottom beam structure 17 consisting of four beams attached together to form a square. At each corner bolt holes 26 are provided. The beam structure 17 is delivered in this shape from the manufacturing site. A platform may be attached to the beam structure when transported.

FIG. 3 illustrates the four beams 18 that are to be used as vertical standing beams of the equipment compartment frame. Each beam 18 has bolt holes 27 at one end thereof. Bolt holes may be provided also at the other end. The beams 18 are transported as they are from the manufacturing site.

FIG. 4 illustrates assembling of an equipment compartment frame 11. Each of the beams 18 are attached to the beam structure 17 by means of bolts 28. This takes place at an assembly site remote from the manufacturing site(s) of the beam structure and the set of beams. The assembly site may be the erection site of the wind turbine or be a separate assembly site, for example where a change of transportation means takes place.

FIG. 5 illustrates a PCM frame 110 in which the PCM (not shown) is mounted and which is arranged for shipping. The lowermost equipment compartment frame 111 forms on each side an open rectangular side limited by two standing beams 118, a part of the bottom beam structure 117 and a part of the top beam structure 119 i.e. the bottom beam structure of the intermediate equipment compartment frame. The lowermost equipment compartment frame 111 is latched by two crossing steel bars 130, 131 connecting respective opposite corners to each other. Thereby the shape stability of the rectangle is secured. Also the other two equipment compartment frames 112, 113 are similarly latched and having additional standing beams 120, 122 and beam structure 121 to limit the compartments as seen in FIG. 5. Other sides (not visible) of the PCM frame 110 may be correspondingly latched.

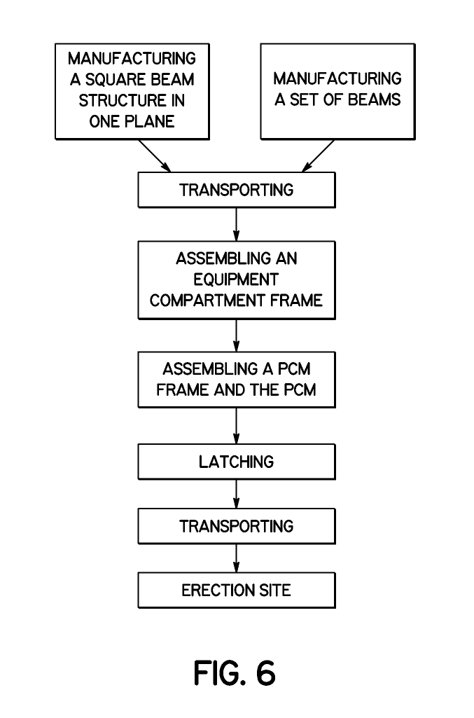

FIG. 6 illustrates a transporting and manufacturing sequence according to the invention. By the text in the boxes and in the context of the above description the figure is supposed to be understood without further explanation.

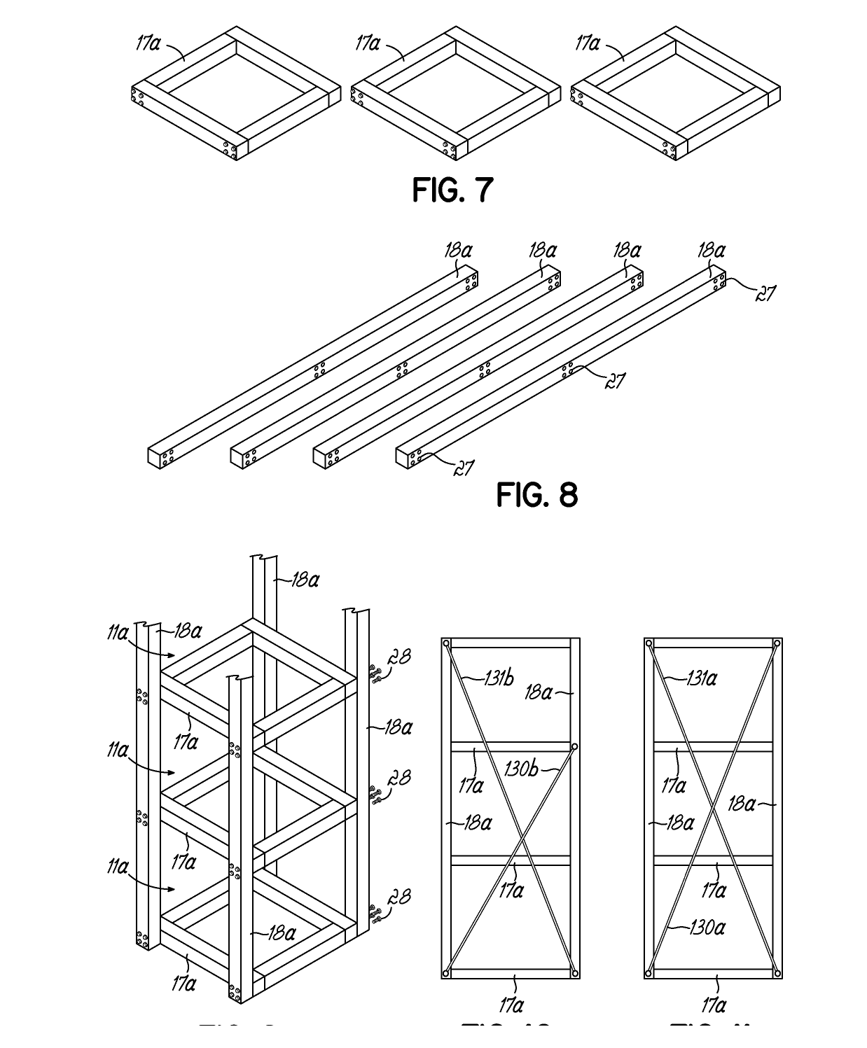

FIG. 7 illustrates three quadrangle beam structures 17a. FIG. 8 illustrates beams 18a that have a length sufficient to be joint to the three quadrangle beam structures 17a shown in FIG. 7. The beams 18a have bolt holes 27 at each end and somewhere there between in the middle region.

FIG. 9 illustrates the frame of a complete PCM with three equipment compartments frames 11a. The PCM is assembled by the parts of FIGS. 7 and 8 by bolting each beam structure 17a to each of the standing beams 18a. Each standing beam 18a thus is common to all three compartments.

FIG. 10 illustrates an alternative latching where a first bar 130b connects diagonally located corners of two adjacent equipment compartment frames, and a second bar 131b connects diagonally located corners of the uppermost and lowermost equipment compartment frames. A further example is illustrated by FIG. 11 comprising the two bars 130a, 131a.

1. An equipment compartment frame of a power control module of a wind turbine, comprising:
a polygonal beam structure in one plane, and
a plurality of standing beams attached to the polygonal beam structure at at least some of the corners of the polygonal beam structure,
wherein each standing beam is attached to the polygonal beam structure by means of a releasable joint.

2. The frame according to claim 1, wherein the polygonal beam structure is a quadrangle having a standing beam at each corner.

3. The frame according to claim 1, wherein the releasable joint is a bolt joint.

4. The frame according to claim 1, wherein the standing beams have a length that exceeds the length required for one equipment compartment frame and is attached to more than one polygonal beam structure.

5. A method for transporting at least one equipment compartment frame of a power control module of a wind turbine, which frame when assembled includes a polygonal beam structure and a plurality of standing beams attached to the polygonal beam structure at at least some of the corners of the polygonal beam structure, the method comprising transporting the equipment compartment frame in an unassembled state in which the standing beams are separated from the polygonal beam structure.

6. The method according to claim 5, further comprising transporting a plurality of polygonal beam structures, wherein the standing beams have a length adapted for the formation of a plurality of equipment compartment frames.

7. A method for assembling at least one equipment compartment frame of a power control module of a wind power turbine, comprising:
providing at least one polygonal beam structure in one plane, wherein the at least one polygonal beam structure is manufactured at a manufacturing site,
providing a plurality of beams intended to be standing beams of the equipment compartment frame, wherein the plurality of beams are manufactured at said manufacturing site or at a second manufacturing site,
transporting the at least one polygonal beam structure and the beams (18, 18a) to an assembly site in an unassembled state in which the beams are separated from the polygonal beam structure, and
at the assembly site, attaching the beams to corners of the at least one polygonal beam structure in standing positions relative to the plane of the polygonal beam structure.

8. The method according to claim 7, further comprising attaching each beam to the at least one polygonal beam structure by a releasable joint.

9. The method according to claim 8, wherein the releasable joint is a bolt joint.

10. A method for transportation of a frame of a power control module of a wind turbine, said frame of the power control module including a plurality of equipment compartment frames, each equipment compartment frame having a plurality of vertical and substantially open sides, each side being an orthogonal quadrangle and being limited by rigid structural elements, the method comprising latching at least one of said sides of at least one equipment compartment frame by at least one diagonally extending rigid bar, or by two crossing, diagonally extending wires.

11. The method according to claim 10, further comprising latching at least one side by two crossing rigid bars.

12. The method according to claim 10, further comprising latching more than one side of said at least one equipment compartment frame.

13. The method according to claim 10, wherein more than one of said equipment compartment frames have at least on side latched.

14. (canceled)
